(19) United States
(12) Patent Application Publication
(10) Pub. No.: US 2015/0163805 A1
(43) Pub. Date: Jun. 11, 2015

(54) OPERATIONS ON SHARED BANDS

(71) Applicant: NOKIA SOLUTIONS AND NETWORKS OY, Espoo (FI)

(72) Inventors: Andrea Cattoni, Nibe (DK); Claudio Rosa, Randers (DK); Antti Sorri, Helsinki (FI); Mikko Aleksi Uusitalo, Helsinki (FI)

(73) Assignee: NOKIA SOLUTIONS AND NETWORKS OY, Espoo (FI)

(21) Appl. No.: 14/399,471

(22) PCT Filed: May 7, 2013
(86) PCT No.: PCT/EP2013/059429

§ 371 Date: Nov. 6, 2014

Related U.S. Application Data
(60) Provisional application No. 61/643,446, filed on May 7, 2012.

(51) Int. Cl. H04W 72/04

(52) U.S. Cl. CPC H04W 72/0453; H04W 84/12

(57) ABSTRACT

A technique comprising: controlling a radio device to make on a first band a radio transmission including information for a plurality of other radio devices about operations at said plurality of other radio devices on a second band more widely shared than said first band.

Expansion in wireless traffic volume will require network operators to continue increasing their wireless capacity. One promising technique is to use shared band(s). Examples of such shared bands include the industrial, scientific and medical (ISM) band in which IEEE 802.11 type networks (generally termed wireless local area networks or WLAN) currently operate, and also what is known as television whitespaces TVWS, which is a very large chunk of spectrum.

Shared bands may be in simultaneous use by different users operating according to different radio access technologies (RATs) such as evolved universal terrestrial radio access network (E-UTRAN) and WLAN.

There has been identified the challenge of better facilitating the use of radio resources in shared bands.

There is hereby provided a method comprising: controlling a radio device to make on a first band a radio transmission including information for a plurality of other radio devices about operations at said plurality of other radio devices on a second band more widely shared than said first band.

There is also hereby provided an apparatus comprising: a processor and memory including computer program code, wherein the memory and computer program code are configured to, with the processor, cause the apparatus to: control a radio device to make on a first band a radio transmission including information for a plurality of other radio devices about operations at said plurality of other radio devices on a second band more widely shared than said first band.

There is also hereby provided an apparatus comprising: means for controlling a radio device to make on a first band a radio transmission including information for a plurality of other radio devices about operations at said plurality of other radio devices on a second band more widely shared than said first band.

There is also hereby provided a computer program product comprising program code means which when loaded into a computer controls the computer to: control a radio device to make on a first band a radio transmission including information for a plurality of other radio devices about operations at said plurality of other radio devices on a second band more widely shared than said first band.

According to one embodiment, said information comprises information of common use by one or more of said plurality of other radio devices.

According to one embodiment, said information comprises information about radio transmissions to and/or from said plurality of other radio devices on said second band.

According to one embodiment, said information identifies one or more radio access technologies for said radio transmissions to and/or from said plurality of other radio devices on said second band.

According to one embodiment, said information comprises information about one or more radio transmissions to one or more of said plurality of other radio devices on said second band, and further comprises a request to one or more of said plurality of other radio devices for channel quality information or channel state information about radio transmissions on said second band.

According to one embodiment, said information comprises information about sensing transmissions on said second band at said plurality of other radio devices.

According to one embodiment, said information comprises an indication for each of said plurality of radio devices of an activation window in an unlicensed band secondary cell, and an indication of modalities in which said plurality of radio devices are to operate in said unlicensed band secondary cell in a transmission mode or a listening mode.

There is also hereby provided a method comprising: controlling a radio device to receive on a first band a radio transmission including information for a plurality of radio devices including said first radio device about operations on a second band more widely shared than the first band; and controlling said first radio device to conduct one or more operations on said second band in accordance with said information.

There is also hereby provided an apparatus comprising: a processor and memory including computer program code, wherein the memory and computer program code are configured to, with the processor, cause the apparatus to: control a radio device to receive on a first band a radio transmission including information for a plurality of radio devices including said first radio device about operations on a second band more widely shared than the first band; and control said first radio device to conduct one or more operations on said second band in accordance with said information.

There is also hereby provided an apparatus comprising: means for controlling a radio device to receive on a first band a radio transmission including information for a plurality of radio devices including said first radio device about operations on a second band more widely shared than the first band; and means for controlling said first radio device to conduct one or more operations on said second band in accordance with said information.

There is also hereby provided a computer program product comprising program code means which when loaded into a computer controls the computer to: control a radio device to receive on a first band a radio transmission including information for a plurality of radio devices including said first radio device about operations on a second band more widely shared than the first band; and control said first radio device to conduct one or more operations on said second band in accordance with said information.

According to one embodiment, said one or more operations on said second band include one or more of the following: making one or more radio transmissions on said second band; receiving one more radio transmissions for said first radio device on said second band; and sensing one or more radio transmissions on said second band.

There is also hereby provided a method comprising: controlling a radio device to make on a first band a radio transmission including modality information for operations on a second band at one or more other radio devices, wherein said second band is more widely shared than said first band.

There is also hereby provided an apparatus comprising: a processor and memory including computer program code, wherein the memory and computer program code are configured to, with the processor, cause the apparatus to: control a radio device to make on a first band a radio transmission including modality information for operations on a second band at one or more other radio devices, wherein said second band is more widely shared than said first band.

There is also hereby provided an apparatus comprising: means for controlling a radio device to make on a first band a radio transmission including modality information for operations on a second band at one or more other radio devices, wherein said second band is more widely shared than said first band.

There is also hereby provided a computer program product comprising program code means which when loaded into a computer controls the computer to: control a radio device to make on a first band a radio transmission including modality information for operations on a second band at one or more other radio devices, wherein said second band is more widely shared than said first band.

According to one embodiment, said modality information identifies one or more radio access technologies for said one or more radio transmissions to and/or from said one or more other radio devices on said second band.

According to one embodiment, said modality information comprises one or more of the following: (i) information about uplink/downlink subframe. configuration for said one or more radio transmissions to and/or from said one or more other radio devices on said second band; (ii) information about version of WLAN standard for one or more radio transmissions to and/or from said one or more other radio devices on said second band; (iii) type of HCCA used for one or more WLAN transmissions to and/or from said one or more other radio devices on said second band; (iv) information about channel sounding for one or more WLAN transmissions to and/or from said one or more other radio devices on said second band; (v) MIMO information for one or more radio transmissions to and/or from said one or more other radio devices on said second band; (vi) information about transmission rank for one or more radio transmissions to and/or from said one or more other radio devices on said second band; and (vii) modulation coding scheme information for one or more radio transmissions to and/or from said one or more other radio devices on said second band.

According to one embodiment, said modality information indicates a listening mode for sensing radio transmissions on said second band at said one or more other radio devices.

According to one embodiment, said listening mode indicates one or more parameters of radio transmissions on said second band to be measured and reported by said one or more other radio devices.

There is hereby provided a method comprising: controlling a radio device to receive a radio transmission on a first band including modality information about one or more operations at said radio device on a second band more widely shared than the first band; and controlling said radio device to conduct one or more operations on said second band in accordance with said modality information.

There is hereby provided an apparatus comprising: a processor and memory including computer program code, wherein the memory and computer program code are configured to, with the processor, cause the apparatus to: control a radio device to receive a radio transmission on a first band including modality information about one or more operations at said radio device on a second band more widely shared than the first band; and control said radio device to conduct one or more operations on said second band in accordance with said modality information.

There is hereby provided an apparatus comprising: means for controlling a radio device to receive a radio transmission on a first band including modality information about one or more operations at said radio device on a second band more widely shared than the first band; and means for controlling said radio device to conduct one or more operations on said second band in accordance with said modality information.

There is hereby provided a computer program product comprising program code means which when loaded into a computer controls the computer to:: control a radio device to receive a radio transmission on a first band including modality information about one or more operations at said radio device on a second band more widely shared than the first band; and control said radio device to conduct one or more operations on said second band in accordance with said modality information.

According to one embodiment, said one or more operations at said radio device on said second band include one or more of the following: making one or more radio transmissions on said second band; receiving one more radio transmissions for said radio device on said second band; and sensing one or more radio transmissions on said second band.

According to one embodiment, said modality information identifies a radio access technology for one or more radio transmissions to and/or from said radio device on said second band.

According to one embodiment, said modality information comprises one or more of the following: (i) information about uplink/downlink subframe configuration for said one or more radio transmissions to and/or from said radio device on said second band; (ii) information about version of WLAN standard for one or more radio transmissions to and/or from said radio device on said second band; (iii) type of HCCA for one or more WLAN transmissions to and/or from said radio device on said second band; (iv) information about channel sounding for one or more WLAN transmissions to and/or from said radio device on said second band; (v) MIMO information for one or more radio transmissions to and/or from said radio devices on said second band; (vi) information about transmission rank for one or more radio transmissions to and/or from said radio device on said second band; and (vii) modulation coding scheme information for one or more radio transmissions to and/or from said radio devices on said second band.

According to one embodiment, said modality information indicates a listening mode for sensing radio transmissions on said second band at said radio device; and further comprising controlling said radio device to conduct sensing of radio transmissions on said second band in accordance with the listening mode indicated by said modality information for said radio device.

According to one embodiment, said listening mode indicates one or more parameters of radio transmissions on said second band to be measured and reported by said one or more other radio devices; and further comprising controlling said radio device to measure and report parameters of radio transmissions on said second band in accordance with the listening mode indicated by said modality information for said radio device.

According to one embodiment, said first band is a licensed band and said second band is an unlicensed band.

The term “licensed band” refers to a band that is exclusively licensed to an operator in a geographical area; and the term “unlicensed band” refers to a band that is not exclusively licensed to said operator in said same geographical area.

Embodiments are described in detail below, by way of example only, with reference to the accompanying drawings, in which:

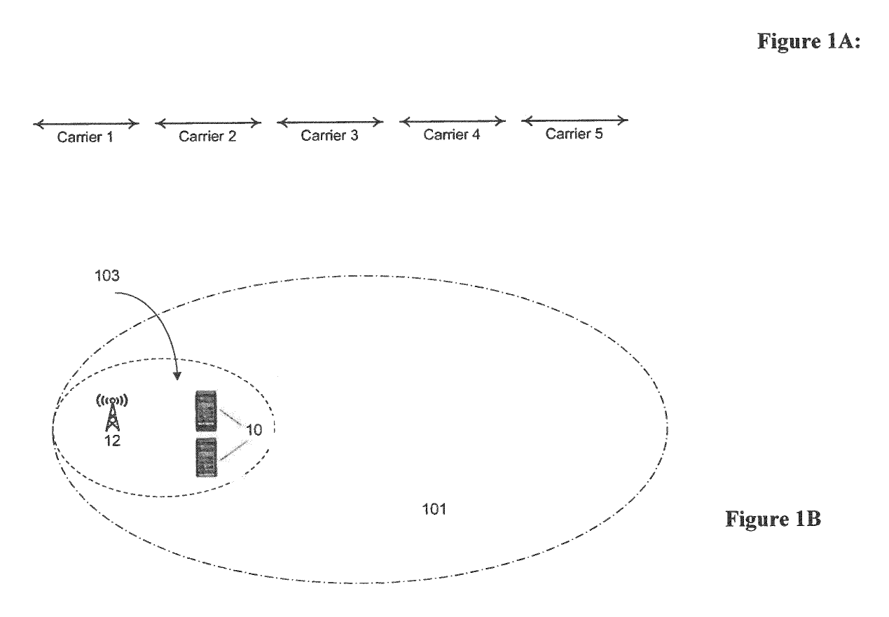

FIG. 1A is a schematic diagram of an example of a radio spectrum utilizing carrier aggregation, specifically five component carrier bandwidths aggregated into a single E-UTRAN bandwidth.

FIG. 1B is an example of a heterogeneous network with one PCell in the licensed band and one SCell in the unlicensed band, and is one non-limiting example of a radio environment in which these teachings can be practiced to advantage.

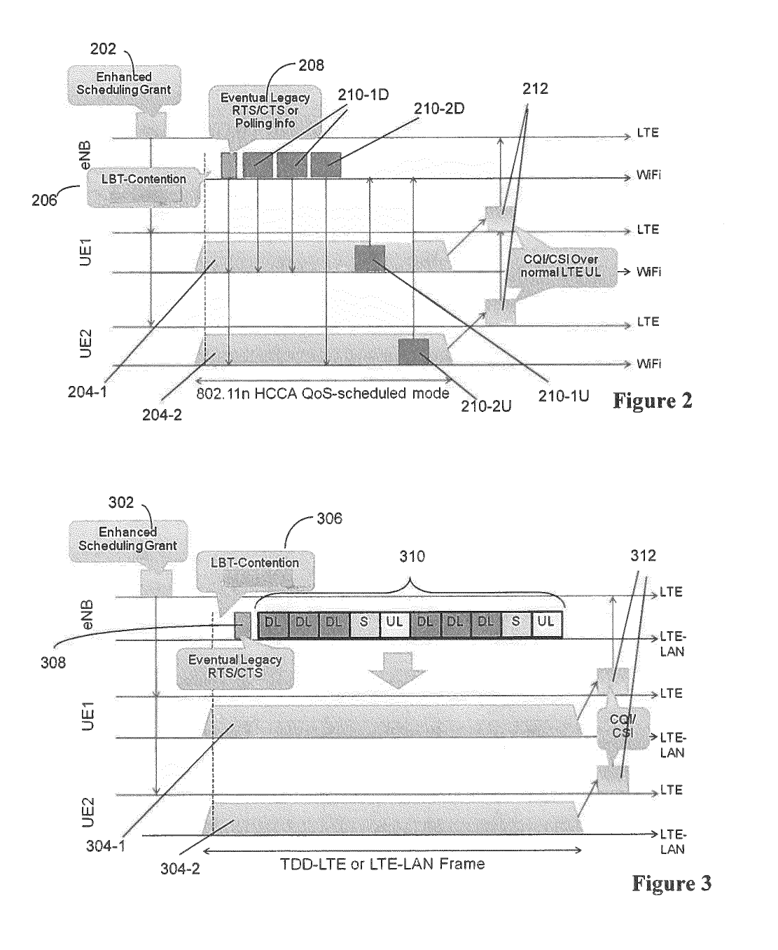

FIG. 2 is a signaling diagram with time progressing along the horizontal axis and illustrating a first non-limiting/exemplary embodiment enabling HCCA operations using an enhanced scheduling grant according to these teachings.

FIG. 3 is a signaling diagram similar to FIG. 2 but illustrating a second non-limiting/exemplary embodiment for time domain operations according to E-UTRAN concepts using an enhanced scheduling grant according to these teachings.

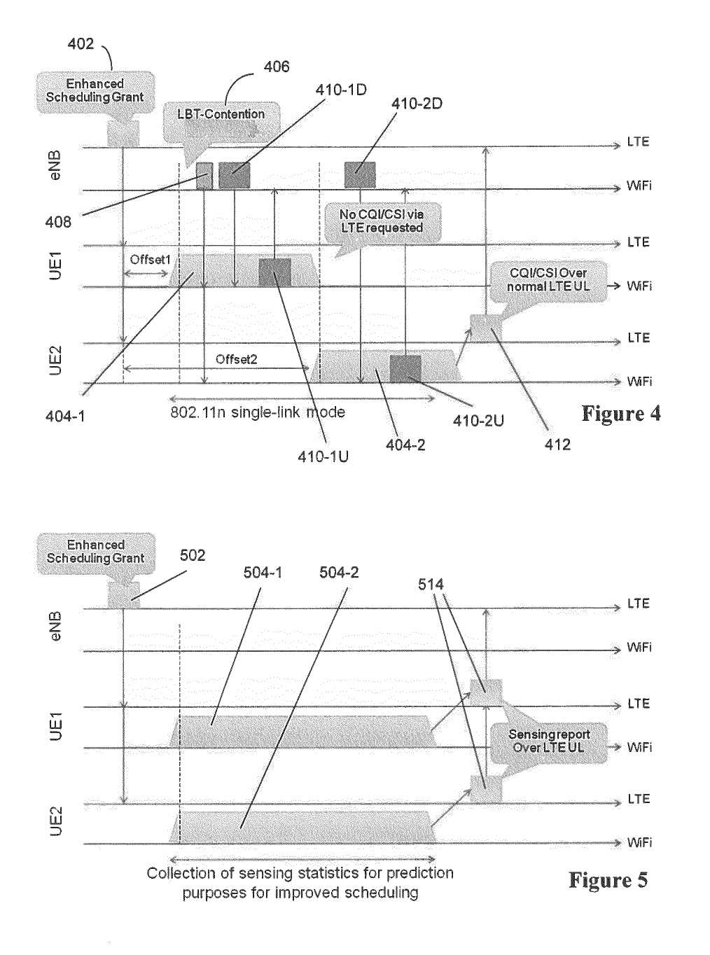

FIG. 4 is a signaling diagram similar to FIG. 2 but illustrating a third non-limiting/exemplary embodiment for per-UE configuration according to WLAN contention-based concepts using an enhanced scheduling grant according to these teachings.

FIG. 5 is a signaling diagram similar to FIG. 2 but illustrating a fourth non-limiting/exemplary embodiment for joint sensing in the unlicensed band and uplink reporting thereof using an enhanced scheduling grant according to these teachings.

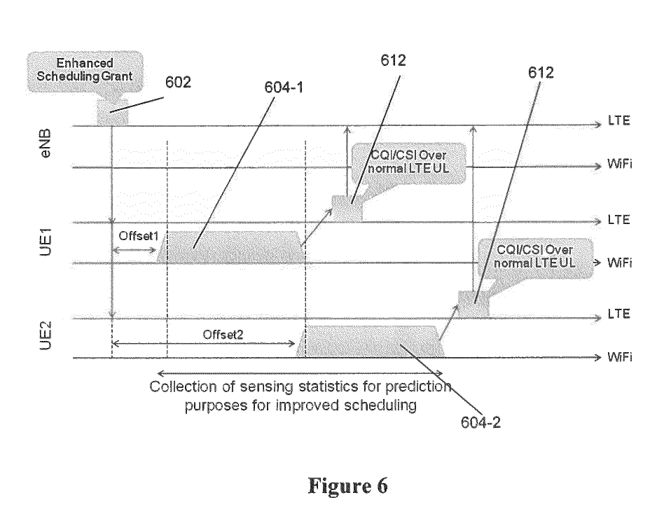

FIG. 6 is a signaling diagram similar to FIG. 2 but illustrating a fifth non-limiting/exemplary embodiment for coordinated listening in the unlicensed band using an enhanced scheduling grant according to these teachings.

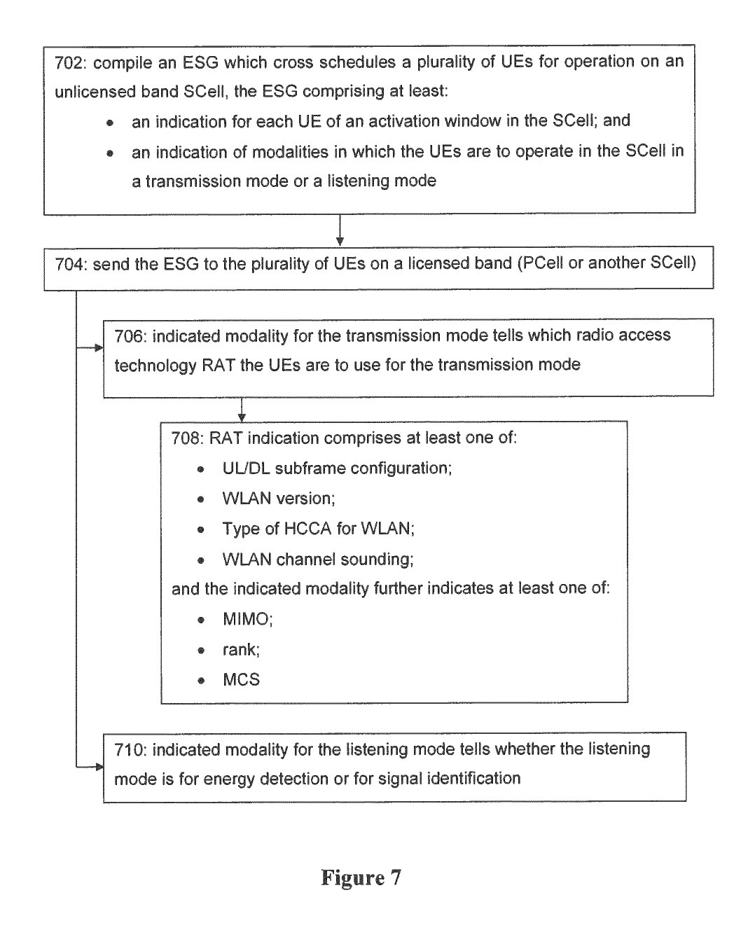

FIG. 7 is an exemplary flow diagram illustrating various embodiments of the invention from the perspective of the eNB/network node.

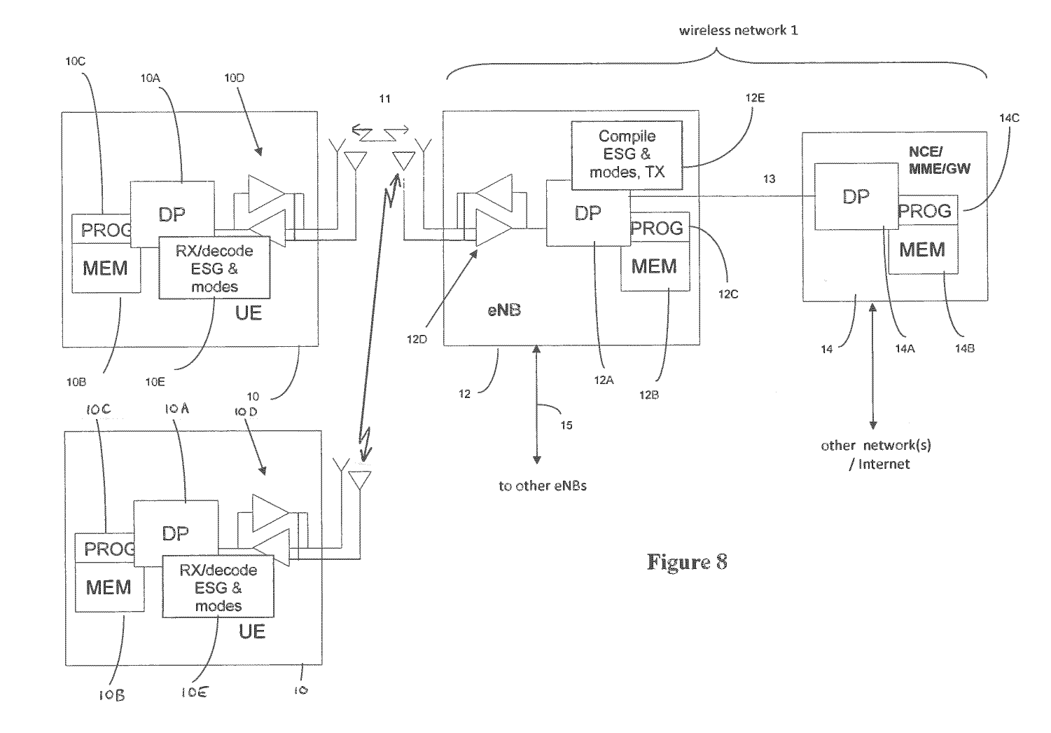

FIG. 8 is a simplified block diagram of a UE and an eNB which are exemplary electronic devices suitable for use in practicing the exemplary embodiments of the invention.

FIG. 1A illustrates one example of carrier aggregated bandwidth in the E-UTRAN system. The whole bandwidth is divided into multiple component carriers (CCs). Each user equipment (UE) 10 in the cell will be configured for one primary component carrier or PCell 101. If a UE 10 is not capable of operation with carrier aggregation it will be assigned a single CC (its PCell) that is backward compatible with 3GPP Release 8. Carrier aggregation capable UEs are assigned one PCell and may be configured also with one or more secondary CCs or SCells 103. Relevant to some embodiments described below, one of those SCells may utilize the license exempt frequencies. Each CC of FIG. 1A is shown to be backwards compatible with Release 8. One or more SCells 103 may not be backward compatible with Release 8, and further one or more SCells 103 may be in the unlicensed band, rendering the overall network a heterogeneous network as shown at FIG. 1B. The radio environment of FIG. 1B has the same network access node 12 operating a WLAN radio in the unlicensed SCell 103 (as a WLAN access point AP) and an E-UTRAN radio in the licensed PCell 101 (as an E-UTRAN eNB). The UE 10 itself may have two radios or may switch a single radio in the time domain between the PCell frequency and RAT and the SCell frequency and RAT, under close tolerances to assure it does not miss important signaling from the eNB 12 on the licensed band.

Offloading traffic from the licensed bands to unlicensed bands may rely on the two different RATS being managed separately except at the core network level, much higher than the access node/eNB 12 of FIG. 1B. In the FIG. 1B example those two RATs are E-UTRAN and WLAN, and offloading to the WLAN is helpful to relieve traffic congestion in the E-UTRAN system. E-UTRAN is also a candidate RAT for use in the unlicensed band. Regardless, devolving management of the traffic offload lower in the network may allow a faster radio resource management (RRM) and thus potentially more efficient use of the scarce radio resources, particularly on the unlicensed band but also on the licensed band.

The examples below are in the context of using the WLAN and the E-UTRAN for the license exempt band, but these teachings can be readily extended to other access schemes for either the licensed or the license exempt bands. Those two major technology candidates for use in the unlicensed SCell can exploit different configurations in order to properly exploit the available time/frequency resources.

It is preferable that all control information be carried on the licensed band (PCell) to ensure robustness, with the SCell being used for data whenever it is available. The license exempt SCell in this case is treated as an expansion carrier. But dual carrier operations, especially when multiple transceivers are involved, are expensive from an energy point of view. This is particularly true at the UE side where the battery consumption is a more pressing concern. While the examples below describe that an enhanced scheduling grant is sent on the PCell, in other embodiments it may be sent on a SCell in the licensed band, which is a different SCell than the unlicensed band which is cross scheduled by that ESG. Cross-scheduling from the PCell is generally the preferred way to implement cross-scheduling in current practice but this is not a limiting factor to these teachings.

For the WLAN system there are of course a variety of relevant standards in the IEEE 802.11 family. At least the 802.11n WLAN system includes channel reservation messages such as request to sent (RTS) and clear to send (CTS) messages that are used to address the well known ‘hidden node’ problem. 802.11n also has adaptive modulation and coding (AMC) as well as contention free periods during which medium access control follows a schedule rather than a contention among competing stations (STAs). For such scheduling in 802.11n there is a hybrid coordination function controlled channel access (HCCA). The related point coordination function (PCF) divides the interval between two beacon frames into a contention free period and a contention period. The HCCA enables a contention free period to be initiated by the AP at almost any time during a contention period when the AP wants to send/receive a frame to/from a STA in a contention free manner. The hybrid coordinator, embodied in the AP, controls access to the radio medium, and the HCCA function enables uplink reporting by the STAs quite precise channel quality indications (CQI) and/or channel state information (CSI) for the license exempt band.

Relevant teachings for heterogeneous network operation in the license exempt band may be seen at document RP-111354 by Intel Corporation and Vodafone entitled NEW STUDY ITEM PROPOSAL FOR RADIO LEVEL DYNAMIC FLOW SWITCHING BETWEEN 3GPP-LTE AND WLAN (3GPP TSG RAN#53, Fukuoka, Japan, 13-16 Sep. 2011), and also at a paper by Lichen Bao and Shenghui Liao entitled SCHEDULING HETEROGENEOUS WIRELESS SYSTEMS FOR EFFICIENT SPECTRUM ACCESS (EURASIP Journal on Wireless Communications and Networking, Vol. 2010, April 2010).

The examples below shown that when the eNB runs an E-UTRAN PCell in the licensed spectrum, and has responsibility for managing the operations of the unlicensed SCell, what is termed herein as an enhanced scheduling grant (ESG) is used to provide to the UEs (which are capable of receiving it and operating on the licensed and unlicensed bands) the required information and grant the operations in the SCell, while maximizing the performance and minimizing the power consumption.

The ESG in the below examples is able to configure unlicensed band operations, and is able to address multiple UEs at the same time with identical or different configurations. Specifically, in the examples for FIGS. 2-6 the ESG is sent via the E-UTRAN system on the licensed band to the UEs that have to be scheduled on the unlicensed SCell (or that are tasked with sensing the unlicensed SCell channel). The E-UTRAN system for transmitting the ESG is only an example; in other implementations other radio access technologies may be used. The ESG can contain aggregated scheduling or sensing information so that all the UEs are being scheduled/activated for sensing with the same modality; or the ESG may use the ESG to schedule/activate on a per UE basis in which, within certain technology-dependent limits, each UE can have a dedicated scheduling/sensing modality. As will be shown at these examples the eNB can utilize the ESG sent over the E-UTRAN licensed band to request CQI/CSI/sensing information for the unlicensed band, and that CQI/CSI reporting is done after the UE's or eNB's transmission which is scheduled by the ESG.

Other examples utilize the ESG to configure some of the more advanced modalities of WLAN, such as for example the quality of service (QoS) scheduled-based HCCA, and multiple input/multiple output (MIMO) transmission techniques, to name but two advanced modalities for UE transmissions on the unlicensed band SCell. The ESG can also be used to dynamically configure the time domain (TD) modalities in E-UTRAN for both the frame and the special subframe according to the traffic needs.

In various embodiments of these teachings the ESG can be triggered by any traffic in the eNB queues and buffers, by UE upload necessities, and/or by periodic/specific sensing needs. In the examples of FIGS. 2-5 the ESG packet is transmitted as control channel information via E-UTRAN on the licensed PCell. In general the ESG will contain the following information:
UEs to be scheduled
Scheduling modality: aggregated or per UE
SCell activation command
SCell carrier configuration (which carrier, for dynamic)
Activation time (Starting offset, Duration)
System
   WLAN
   TD E-UTRAN (or E-UTRAN on the unlicensed band)
If listening mode
   Type of listening mode (“energy detection”, “signal identification”)—Mode Identification and Spectrum Monitoring (MISM)
If uplink/downlink (UL/DL) Transmission
   Transmission Type
      UL and DL configuration (e.g. #1, #2, #3 of time domain duplex TDD-EUTRAN, which tells how many UL and DL subframes there are)
      Configuration of the special subframes S (e.g. #5, #6, #7)
      WLAN version (IEEE 802.11g; 802.11n-high throughput; 802.11n-hybrid)
      HCCA for WLAN, type of HCCA
      WLAN channel sounding
   Transmission Mode
      MIMO, Rank, modulation and coding scheme (MCS)
Request of post-transmission CQI/CSI/sensing report via PCell UL

With these general concepts in mind, now consider the specific but non-limiting examples at FIGS. 2-6 for different deployments/use-cases. First consider FIG. 2 in which the ESG configures the SCell for HCCA operations. In this example traffic at the eNB side triggers the SCell activation. Specifically, the eNB 12 sends the ESG 202 on the licensed band to two UEs, UE1 and UE2. Two UEs is merely an example; the ESG in any of FIGS. 2-6 may address more than two. The ESG 202 in FIG. 2 is sent for aggregated configuration of the WLAN SCell in order to exploit the scheduled, contention-free HCCA modality for both UE1 and UE2. In this case the WLAN SCell may be accessed via traditional unsynchronized carrier sense multiple access with collision avoidance (CSMA/CA), or via synchronized listen-before-transmit (or listen-before-talk) LBT, or the conventional WLAN request-to-send/clear-to-send RTS/CTS message exchange. All of these are intended to prevent collisions before they occur. Or alternatively the ESG may specify that E-UTRAN is to be used on the SCell, in which case the access may for example be via synchronized LBT. Further details concerning non-limiting implementations of synchronized LBT, alone or combined with RTS/CTS signaling, may be seen in co-owned provisional U.S. patent application Ser. No. 61/570,909 (filed Dec. 15, 2011) entitled RADIO OPERATIONS IN A CARRIER AGGREGATION SYSTEM by inventors Rapeepat Ratasuk, Nitin Mangalvedhe, Mikko A. Uusitalo and Antti S. Sorri. Finally at FIG. 2 the UE1 and UE2 provide to the eNB on the licensed band CQI/CSI feedback which was also indicated in the ESG 202 (inherent in the ESG 202 indication of the transmission type as HCCA QoS scheduled mode), in order to improve the next subsequent transmission.

The ESG 202 sent on the licensed band grants to UE1 two downlink slots 210-1D in the unlicensed band and one uplink slot 210-1U in the unlicensed band. That same ESG 202 also grants to UE2 one downlink slot 210-2D in the unlicensed band and one uplink slot 210-2U in the unlicensed band. The ESG 202 triggers the UE1 and UE2 to activate the SCell in the unlicensed band, which is illustrated at FIG. 1 by UE1 and UE2 becoming active in their respective SCell activation windows 204-1, 204-2. The length of these windows 204-1, 204-2 is the duration specified in the ESG 202.

If operations on the unlicensed band are according to WLAN then the eNB 12 may send a poll (contention free) or a RTS message (contention) to assure that no other transmissions interfere with the DL data it is about to send. If RTS then the UE1 and UE2 each reply with a CTS, so that the RTS/CTS pair acts as a network allocation vector to inform other parties that the channel is ‘reserved’ for a time. This is shown generally at block 208 of FIG. 2. Or for WLAN operations on the SCell the eNB 12 can use a listen before transmit/talk (LBT) silence period (alone or in combination with a RTS/CTS message exchange) to check before it transmits that the channel is clear and thus aid in avoiding interference, or it can use unsynchronized CSMA/CA to access the WLAN SCell. If instead operations on the unlicensed band are according to E-UTRAN then the eNB 12 can still use synchronized LBT for channel access. This is shown generally at block 206 of FIG. 2. Synchronized LBT can be realized through simple clear channel assessment as is known in the wireless arts. The WLAN system also uses a silence period in its contention based access but in WLAN this general concept is termed a backoff period, which in an exemplary embodiment of these teachings can also be used with the additional RTS/CTS exchange to alert any ‘hidden’ nodes of the pending transmission. So in summary, if the access to the SCell is contention based it can be unsynchronized with the PCell (such as CSMA/CA if the SCell is using WLAN) or synchronized with the PCell (such as LBT regardless of whether the SCell is using WLAN or E-UTRAN). Alternatively or in addition to LBT the RTS/CTS message exchange can also be used for accessing the SCell when WLAN is in use on it.

The eNB 12 transmits the DL slots/subframes 210-1D and 210-2D on the unlicensed-band SCell and the respective UEs transmit their UL subframes 210-1U, 210-2U on the unlicensed-band SCell according to the schedule set forth in the ESG 202 which cross scheduled from the licensed-band PCell. Following their respective SCell activation windows 204-1, 204-1 each of UE1 and UE2 then send on the licensed-band PCell the report of CQI and/or CSI 212 which they respectively sensed on the unlicensed-band SCell.

In summary the ESG 202 of the FIG. 2 example identifies UE1 and UE2; specifies that the scheduling is aggregated; activates the unlicensed band SCell;, gives the start time (dotted vertical line in FIG. 2) and duration of the SCell activation windows 204-1, 204-2; tells that operations on the SCell are to utilize WLAN; informs the UE1 and UE2 that the transmission type is to be HCCA QoS scheduled mode and the MCS for those transmissions; and requests the UE1 and UE2 each send CQI/CSI uplink on the licensed PCell.

FIG. 3 illustrates the case in which the ESG 302 configures the unlicensed-band SCell for time domain TD E-UTRAN operations. In this case the eNB is scheduling UE1 and UE2 for traffic in different time domains, and the operations on the unlicensed band utilize the E-UTRAN RAT same as on the licensed band.

Like FIG. 2, FIG. 3 assumes that traffic at the eNB side triggers the SCell activation. The ESG 302 is sent for aggregated configuration of the UEs in the TD E-UTRAN SCell in order to exploit frame configuration #3 and special S subframe configuration #7 (shown in FIG. 3 by reference number 310) so as to achieve the maximum DL capacity. The CQI/CSI 312 is reported via the PCell in order to ensure a safe transmission (that is, low error probability). Conventional RTS/CTS packets 308 could be exchanged prior to occupying the unlicensed E-UTRAN SCell channel in order to reserve it and avoid collisions with other radios. Or if the ESG 302 configured the SCell for E-UTRAN operation the eNB could impose on itself a LBT silence period at 306 to help avoid interference in the unlicensed band.

In summary the ESG 302 of the FIG. 3 example identifies UE1 and UE2; specifies that the scheduling is aggregated; activates the unlicensed band SCell;, gives the start time (dotted vertical line) and duration of the SCell activation windows 304-1, 304-2; configures the UEs to operate on the SCell using E-UTRAN; informs the UE1 and UE2 that the transmission type is to be E-UTRAN frame configuration #3 subframe configuration #7 and the MCS for those transmissions; and requests the UE1 and UE2 each send CQI/CSI uplink on the licensed PCell.

FIG. 4 illustrates the case in which the ESG 402 configures the unlicensed-band SCell on a per-UE basis for WLAN single-link contention based operations. In this case the eNB is activates UE1 and UE2 for different SCell activation windows 404-1, 404-2, for which the ESG 402 gives a time offset (offset1, offset2 in FIG. 4) for each to indicate the start of each window. The ESG 402 also indicates that operations on the unlicensed band utilize the WLAN RAT.

Like FIG. 2, FIG. 4 assumes that traffic at the eNB side triggers the SCell activation but above it was also indicated this can be triggered by uplink traffic by the UEs (or by a need for the eNB to obtain sensing information, but FIG. 4 is not optimum for that scenario). The ESG 402 is sent for configuring each UE independently (non-aggregated) for each UE to receive the assumed downlink data in the WLAN SCell. The ESG 402 requests CQI/CSI 412 from UE2 only; some exemplary reasons CQI/CSI is not requested of UE1 may be due to connection closure or background traffic QoS. Once the first activation window 404-1 for UE1 begins then UE1 contends for access on the WLAN channel, and there is shown an exchange 408 of RTS and CTS packets to reserve the channel. If instead the ESG 402 designated that the SCell would use E-UTRAN then instead of the RTS-CTS exchange the eNB can use a LBT silence period 406 to help avoid interference in the unlicensed band from other transmitting entities.

During the SCell activation window 402-1 for UE1 the eNB sends downlink data 410-1D and if the UE1 also has uplink data 410-1U it also sends it. Similar is true 410-2D, 410-2U for UE2 during its separate SCell activation window 404-2, except in this case since the ESG 402 directed that only UE2 send CQI/CSI then at the close of its activation window 404-2 then UE2 sends the CQI/CSI 412 that it measured on the unlicensed band.

The ESG 402 of the FIG. 4 example identifies UE1 and UE2; specifies that the scheduling is per-UE; activates the unlicensed band SCell; gives the start time (offsets) and duration of the windows 404-1, 404-2; configures the UEs to operate on the SCell using WLAN; informs the UE1 and UE2 that the transmission type is to be 802.11g or 802.11n (for example); and requests that only UE2 send CQI/CSI uplink on the licensed PCell.

FIG. 5 is similar to FIG. 3 except in this case the ESG 502 schedules the UEs for a joint listening mode, from which they each report on the licensed band PCell the results of their sensing on the unlicensed band SCell. There is no traffic so the ESG 502 of FIG. 5 is triggered by the eNB's need for information about the SCell channel in the unlicensed band. For example, the eNB may choose to gather this information for selection/re-selection of a specific carrier for SCell operations (that is, to assess whether this SCell is currently appropriate for offloading traffic), or to collect statistics for eventual improvements in the scheduling process.

The ESG 502 of FIG. 5 thus identifies UE1 and UE2; specifies that the scheduling is aggregated; activates the unlicensed band SCell; gives the start time and duration of the windows 504-1, 504-2 which in this case are contemporaneous since the sensing is joint among both UEs; and requests that both UE1 and UE2 send their sensing reports 514 uplink on the licensed PCell.

Since FIG. 5 is sensing only, there is no need for the ESG 502 to specify any transmission type (what radio access technology the UEs should use), but instead it specifies the listening modality, such as whether it is for energy detection or signal identification for example. This mode specification also saves energy at the UE since the UEs can then tailor the scope of their sensing to what the eNB needs; for the energy detection mode the UEs' reports 514 may only indicate received signal strengths whereas for the signal identification mode the UEs' reports 514 are likely to be much more extensive, including what RAT is in use on the SCell band. Such signal analysis consumes much more of a UEs limited power supply than simple signal strength measurements.

FIG. 6 is similar to FIG. 5 but the UEs are configured by the ESG 602 for a coordinated listening mode and so their respective SCell activation windows 604-1, 604-2 are not contemporaneous. The ESG 602 indicates this listening modality by different start time offsets. In FIG. 6 also each of the UEs send their CQI/CSI 614 or other sensing report information on the licensed band using E-UTRAN specifications.

The above embodiments are summarized and assembled at FIG. 7, which is a logic flow diagram that illustrates the operation of a method, and a result of execution of computer program instructions, in accordance with the exemplary embodiments of this invention. In accordance with these exemplary embodiments for a carrier aggregation system comprising multiple component carriers (at least one PCell and at least one SCell), block 702 shows the compiling of an enhanced scheduling grant ESG which cross schedules a plurality of UEs for operation on an unlicensed band SCell, the ESG comprising at least an indication for each UE of an activation window in the SCell; and an indication of modalities in which the UEs are to operate in the SCell in a transmission mode or a listening mode. Then once compiled block 704 shows the ESG is sent to the plurality of UEs on a licensed band. While the examples above had the ESG sent in the licensed band PCell, in other embodiments it may be sent on a licensed band SCell which cross schedules to the unlicensed band SCell. The carrier aggregation system still has a PCell for each UE but in these other implementations where the PCell is not used for the ESG only SCells are used to implement these teachings.

Remaining blocks of FIG. 7 are optional particular embodiments, any of which may be combined with blocks 702 and 704. Block 706 describes that the indication of the modalities that the UEs are to operate in the SCell in the transmission mode comprises an indication of which radio access technology RAT the UEs are to use for the transmission mode. For example, and as more particularly shown at block 708, the transmission mode/RAT indication can also inform the UEs of the transmission type (the UL/DL subframe configuration for an E-UTRAN system, or WLAN version, or type of HCCA for WLAN, or WLAN channel soundings), and also the indication of the modalities can further inform the UEs of the transmission mode (multiple input multiple output MIMO, and/or transmission rank, and/or modulation and coding scheme MCS).

If instead a particular ESG indicates the modality that the UEs are to operate in the SCell in the listening mode, then at block 710 the ESG will also indicate whether the listening mode is for energy detection or for signal identification. of the modalities

The above examples presented further options for the ESG not specifically shown at FIG. 7. For example, the specific means by which the ESG indicates the activation window may be an offset indication and a duration indication. Also in the examples above the ESG may further have an indication whether the plurality of UEs are scheduled per-UE or aggregated. In each of the examples above the ESG also served the dual purpose of activating the SCell for the plurality of UEs. And whether inherent in the HCCA QoS scheduled mode or more explicit, if we assume that the ESG is sent on the PCell then the ESG can in some embodiments further indicate which of the plurality of UEs are to send on the PCell a sensing report of the SCell.

The various blocks shown in FIG. 7 may be viewed as method steps, and/or as operations that result from operation of computer program code embodied on a memory and executed by a processor, and/or as a plurality of coupled logic circuit elements constructed to carry out the associated function(s).

Reference is made to FIG. 8 for illustrating a simplified block diagram of various electronic devices and apparatus that are suitable for use in practicing the exemplary embodiments of this invention. In FIG. 8 a wireless network 1 is adapted for communication over a wireless link 11 with an apparatus, such as a mobile communication device which above is referred to as a UE 10, via a network access node, such as a Node B (base station), and more specifically an eNB 12. The network 1 may include a network control element (NCE) 14 that may include mobility management entity/serving gateway MME/S-GW functionality that is specified for the E-UTRAN system (the E-UTRAN system is also known as long term evolution LTE or long term evolution-advanced LTE-A). The NCE 14 also provides connectivity with a different network, such as a publicly switched telephone network and/or a data communications network (e.g., the Internet). While only one wireless link 11 is shown, this represents multiple logical and physical channels, on the PCell and on the SCell.

The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transmitter and receiver 10D for bidirectional wireless communications with the eNB 12 via one or more antennas (two shown). The UE 10 may have one or two radios 10D for communicating over both the licensed band PCell and the unlicensed band SCell.

The eNB 12 also includes a controller, such as a computer or a data processor (DP) 12A, a computer-readable memory medium embodied as a memory (MEM) 12B that stores a program of computer instructions (PROG) 12C, and suitable RF transmitters and receivers (only one shown as 12D) for communication with the UE 10 via one or more antennas (also two shown) on the PCell and on the SCell. The eNB 12 is coupled via a data/control path 13 to the NCE 14. The path 13 may be implemented as the S1 interface known in the E-UTRAN system. The eNB 12 may also be coupled to another eNB via data/control path 15, which may be implemented as the X2 interface known in the E-UTRAN system.

At least one of the PROGs 10C and 12C is assumed to include program instructions that, when executed by the associated DP, enable the device to operate in accordance with the exemplary embodiments of this invention, as detailed above. That is, the exemplary embodiments of this invention may be implemented at least in part by computer software executable by the DP 10A of the UE 10 and/or by the DP 12A of the eNB 12, or by hardware, or by a combination of software and hardware (and firmware).

For the purposes of describing the exemplary embodiments of this invention the eNB 12 may be assumed to also include a program or algorithm to cause the eNB to compile and send (transmit TX) the ESG with its indications of modalities in which the UEs are to operate in the SCell in transmission mode or listening mode as detailed above, and the UE 10 also has a program or algorithm to receive (RX) and decode and act upon (adopt the modalities of) the ESG it receives on the PCell as shown at 10E and 12E of FIG. 8, according to the non-limiting examples presented above.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multicore processor architecture, as non-limiting examples.

In general, the various exemplary embodiments may be implemented in hardware or special purpose circuits, software, logic or any combination thereof. For example, some aspects may be implemented in hardware, while other aspects may be implemented in embodied firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, embodied software and/or firmware, special purpose circuits or logic, general purpose hardware or controller or other computing devices, or some combination thereof, where general purpose elements may be made special purpose by embodied executable software.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

While the exemplary embodiments have been described above in the context of the E-UTRAN system, it should be appreciated that the exemplary embodiments of this invention are not limited for use with only this one particular type of wireless communication system that uses carrier aggregation with cross-scheduling.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1.-50. (canceled)

51. A method comprising:
controlling a radio device to make on a first band a radio transmission including modality information for operations on a second band at one or more other radio devices, wherein said second band is more widely shared than said first band.

52. A method according to claim 51, wherein said modality information identifies one or more radio access technologies for said one or more radio transmissions to and/or from said one or more other radio devices on said second band.

53. A method according to claim 52, wherein said modality information comprises one or more of the following:
(i) information about uplink/downlink subframe configuration for said one or more radio transmissions to and/or from said one or more other radio devices on said second band;
(ii) information about version of WLAN standard for one or more radio transmissions to and/or from said one or more other radio devices on said second band;
(iii) type of HCCA used for one or more WLAN transmissions to and/or from said one or more other radio devices on said second band;
(iv) information about channel sounding for one or more WLAN transmissions to and/or from said one or more other radio devices on said second band;
(v) MIMO information for one or more radio transmissions to and/or from said one or more other radio devices on said second band;
(vi) information about transmission rank for one or more radio transmissions to and/or from said one or more other radio devices on said second band; and
(vii) modulation coding scheme information for one or more radio transmissions to and/or from said one or more other radio devices on said second band.

54. A method according to claim 51, wherein said modality information indicates a listening mode for sensing radio transmissions on said second band at said one or more other radio devices.

55. A method according to claim 54, wherein said listening mode indicates one or more parameters of radio transmissions on said second band to be measured and reported by said one or more other radio devices.

56. A method comprising:
controlling a radio device to receive a radio transmission on a first band including modality information about one or more operations at said radio device on a second band more widely shared than the first band; and
controlling said radio device to conduct one or more operations on said second band in accordance with said modality information.

57. A method according to claim 56, wherein said one or more operations at said radio device on said second band include one or more of the following:
making one or more radio transmissions on said second band;
receiving one more radio transmissions for said radio device on said second band; and
sensing one or more radio transmissions on said second band.

58. A method according to claim 56 wherein said modality information identifies a radio access technology for one or more radio transmissions to and/or from said radio device on said second band.

59. A method according to claim 58, wherein said modality information comprises one or more of the following:
(i) information about uplink/downlink subframe configuration for said one or more radio transmissions to and/or from said radio device on said second band;
(ii) information about version of WLAN standard for one or more radio transmissions to and/or from said radio device on said second band;
(iii) type of HCCA for one or more WLAN transmissions to and/or from said radio device on said second band;
(iv) information about channel sounding for one or more WLAN transmissions to and/or from said radio device on said second band;
(v) MIMO information for one or more radio transmissions to and/or from said radio devices on said second band;
(vi) information about transmission rank for one or more radio transmissions to and/or from said radio device on said second band; and
(vii) modulation coding scheme information for one or more radio transmissions to and/or from said radio devices on said second band.

60. A method according to claim 59, wherein said modality information indicates a listening mode for sensing radio transmissions on said second band at said radio device; and
further comprising controlling said radio device to conduct sensing of radio transmissions on said second band in accordance with the listening mode indicated by said modality information for said radio device.

61. A method according to claim 60, wherein said listening mode indicates one or more parameters of radio transmissions on said second band to be measured and reported by said one or more other radio devices; and
further comprising controlling said radio device to measure and report parameters of radio transmissions on said second band in accordance with the listening mode indicated by said modality information for said radio device.

62. An apparatus comprising:
a processor and memory including computer program code, wherein the memory and computer program code are configured to, with the processor, cause the apparatus to:
control a radio device to make on a first band a radio transmission including modality information for operations on a second band at one or more other radio devices, wherein said second band is more widely shared than said first band.

63. An apparatus comprising:
a processor and memory including computer program code, wherein the memory and computer program code are configured to, with the processor, cause the apparatus to:
control a radio device to receive a radio transmission on a first band including modality information about one or more operations at said radio device on a second band more widely shared than the first band; and
control said radio device to conduct one or more operations on said second band in accordance with said modality information.

64. A computer program product comprising program code which when loaded into a computer controls the computer to:
control a radio device to make on a first band a radio transmission including modality information for operations on a second band at one or more other radio devices, wherein said second band is more widely shared than said first band.

65. A computer program product comprising program code which when loaded into a computer controls the computer to:
control a radio device to receive a radio transmission on a first band including modality information about one or more operations at said radio device on a second band more widely shared than the first band; and
control said radio device to conduct one or more operations on said second band in accordance with said modality information.
